(19) United States
(12) Patent Application Publication
(10) Pub. No.: US 2010/0157999 A1
(43) Pub. Date: Jun. 24, 2010

(54) NETWORK CAPABLE OF M3UA-BASED NETWORKING, APPARATUS AND MESSAGE TRANSFER METHOD

(75) Inventors: Zhuohui LEI, Shenzhen (CN); Nengyi PAN, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/716,508

(22) Filed: Mar. 3, 2010

Related U.S. Application Data
(63) Continuation of application No. PCT/CN2008/072135, filed on Aug. 25, 2008.

(30) Foreign Application Priority Data
Sep. 5, 2007 (CN) 200710147364.2

(51) Int. Cl. H04L 12/56

(52) U.S. Cl. 370/389

(57) ABSTRACT

A network capable of M3UA-based networking, an apparatus, and a message transfer method are disclosed herein. The network includes: an IPSTP, configured to: perform signaling interworking with an IPSEP and/or other IPSTPs in the network, and maintain routes dynamically; and an IPSEP, configured to perform signaling interworking with the IPSTP. The network, the apparatus and the method under the present invention accomplish the M3UA-based networking throughout the network, especially, sophisticated M3UA-based networking

### CROSS-REFERENCE TO RELATED APPLICATIONS

This application is a continuation of International Patent Application No. PCT/CN2008/072135, filed Aug. 25, 2008, which claims priority to Chinese Patent Application No. 200710147364.2, filed Sep. 6, 2007, both of which are hereby incorporated by reference in their entireties.

### FIELD OF THE INVENTION

The present invention relates to a technology of transmitting signaling in an Internet Protocol (IP) network, and in particular, to a network that supports networking based on the Message Transfer Part 3 User Adaptation Layer (M3UA) protocol, an apparatus, and a message transfer method.

BACKGROUND

The Signaling System No.7 (SS7) is one of the three major traditional telecommunications support networks. The SS7 transfers the instruction-like information through digital signaling channels to unify normal communication and harmonious operation between different nodes in a service network, between different service networks, and between a service network and a subscriber device.

The functions of an SS7 system are divided into four layers: signaling data link layer (MTP Layer 1), signaling link control layer (MTP Layer2), signaling network function layer (MTP Layer 3), and user part function layer. A signaling network independent of service networks exists in the SS7 system. The signaling network transfers not only call control signaling, but also other maintenance information about network services and network management. The signaling network is made up of basic Network Elements (NEs), which are also known as nodes. Depending on the functions provided, nodes fall into two types: Signaling Point (SP), and Signaling Transfer Point (STP). FIG. 1 shows a structure of a signaling network in the conventional art. In this signaling network, signaling interaction is performed between SPs either through an STP or directly, and an SP is also called a Signaling End Point (SEP). SEPs may be interconnected through one or more STPs or through signaling links to perform signaling interaction between end offices.

In the MTP Layer 3 of the SS7 system, the network-layer function is to transfer an upper-layer (user part) message from the origination SP to the destination SP. This function is performed through the MTP3 protocol. The network-layer function of the MTP3 protocol includes two parts: signaling message processing, and signaling network management.

Signaling message processing includes three basic functions: message identification, message distribution, and message routing, through which a signaling is guided to a proper signaling link and the upper-layer user part.

Signaling network management includes signaling service management, signaling link management, and signaling route management, and controls the serial number of messages and the combination of signaling network devices, with a view to maintaining and recovering normal message transfer capabilities. Signaling route management aims to ensure the information about the signaling network state to be transferred between nodes reliably. Described below are signaling messages and processing flows related to MTP3 signaling route management.

An MTP3 route manager is responsible for exchanging route state information between nodes. When an event occurs and affects route effectiveness, the MTP3 route manager notifies other nodes of the route state. The MTP3 route manager also provides route information for the MTP3 signaling service manager so that the MTP3 signaling service manager can adjust its service mode and traffic.

Each node in the SS7 system maintains the remote route state information. The node updates the destination node state information stored in the node according to the received route management message. In this way, the node selects a proper route to transmit signaling according to the route state. Generally, a route may be in one of these three states: (1) Allowed; (2) Prohibited; and (3) Restricted.

The MTP3 route manager notifies the route state of a node to other nodes through the following route management messages:

Transfer Prohibited (TFP) message: When the destination signaling route changes to be unavailable, the STP sends a TFP message to the relevant node. The node that receives the TFP message needs to execute the forced rerouting program, namely, adjust the state of relevant local route, and transfer the signaling from a TFP route to a Transfer Allowed (TFA) signaling route.

Transfer Allowed (TFA) message: When the destination signaling route changes to be available, the STP sends a TFA message to the relevant node. The node that receives the TFP message needs to execute the controlled rerouting program, namely, adjust the state of a relevant local route, and transfer the signaling to a TFA signaling route according to the set policy.

Transfer Restricted (TFR) message: If an STP expects to let a node transmit the relevant service as seldom as possible, the STP sends a TFR message to the node. The node that receives the TFR message needs to execute the controlled rerouting program.

Transfer Controlled (TFC) message: When a signaling route is congested, the STP sends a TFC message to the neighboring node, indicating congestion of the signaling route. The node that receives the TFC message needs to execute a signaling traffic control program, and decreases the signaling traffic properly according to the detected traffic conditions.

With respect to the MTP3 route management mechanism of the SS7 system, the relevant node is triggered through the foregoing message events of triggering node state change. Moreover, each node may query the state of the relevant node proactively, namely, SS7 Route Set Test (RST). The process of proactive query is: When a remote fault of the SS7 system occurs, the TFP message is used together with the TFA message to test whether the signaling of a destination node can be transferred through a nearby STP. Specifically, when a node receives a TFP message from a nearby STP, the node sends an RST message to the STP periodically until receiving a TFA message.

In order to transmit the route state information of the node and the user information, the MTP3 protocol defines the message format. FIG. 2 shows the message format defined by the MTP3 protocol in the conventional art. The format is called a Message Signal Unit (MSU), which includes: flag bit (F), Backward Sequence Number (BSN), Forward Sequence Number (FSN), Forward Indicator Bit (FIB), Length Indicator (LI), Check Bit (CK), Signaling Information Field (SIF), and Service Information Octet (SIO).

FIG. 3 shows how a signaling service message is carried in a message format shown in FIG. 2 in the conventional art. The SIF includes information content and a route flag. The route flag includes a Destination Point Code (DPC), an Origination Point Code (OPC), and a Signaling Link Code (SLC). The data in the message is set in the information content field, and the origination node information and the destination node information of the message are set in the route flag field. In the SS7 system, the node address is identified through a Signaling Point Code (SPC).

FIG. 4 shows how a route management message is carried in a message format shown in FIG. 2 in the conventional art. In this format, the SIF includes a management message and a route flag. The specific management message content is set in the management message field. For example, at the time of transmitting a TFP message, a TFA message, or a TFR message, a destination is set (to indicate the DPC that undergoes node change); at the time of transmitting a TFC message, a destination is set (to indicate DPC that suffers SP congestion) and a congestion level is set (to indicate the congestion level); at the time of transmitting an RST message, a destination is set (to indicate the DPC that needs detection of the node state); at the time of transmitting a node upper-layer user state message, namely, a User Part Unavailable (UPU) signal message, a user part identifier and a destination are set (to indicate that a “user part” of a destination node address is unavailable; after receiving this message, the MTP3 Layer 3 of the node notifies the local upper-layer user so that the upper-layer user takes measures in time).

With the development of the IP packet network, the IP packet network is capable of bearing the services such as voice service, data service, and multimedia service. The traditional circuit switching network and IP packet network are being integrated. In order to implement interworking between the traditional circuit switching network and the IP packet network, circuit switching signaling such as SS7 needs to be transmitted on the IP network. The M3UA protocol is a protocol for transmitting signaling on an IP network. The conception of the M3UA protocol is to set a Signaling Gateway (SG) between the SS7 system and an IP-based network. Moreover, the M3UA protocol is proposed to transmit the signaling in an SS7 system transparently to an MTP3 upper-layer user of a node in an IP-based network. In order to implement interworking between the SS7 system and the IP-based network, the network may be formed in the M3UA SG-Application Server (AS) mode. As shown in FIG. 5, the SG is set between the SS7 system and the IP-based network. The SG is an NE in the IP-based network, and interworks with the STP in the SS7 system through an MTP3 protocol and interworks with the AS through an M3UA protocol. The M3UA protocol also defines a Signaling Gateway Process (SGP) for the SG, and defines an Application Server Process (ASP) for the AS, where the ASP in each AS may serve one or more nodes.

With a view to the IP-based implementation throughout a network in the future, the M3UA protocol defines another peer IP application mode, namely, a mode of interworking between IP-based Signaling Pints (IPSPs) through the M3UA protocol, as shown in FIG. 6. In this mode, all IPSPs are interconnected directly, without requiring signaling transfer of an STP in the SS7.

The M3UA protocol specifies clearly that the SG notifies the AS through an M3UA-based route management message when the state of a node in the SS7 system changes. The format of the M3UA-based network management messages is shown in FIG. 8a, FIG. 8b, and FIG. 8c. FIG. 8a shows the format of the Destination Unavailable (DUNA) message or Destination Available (DAUA) message, or Destination State Audit (DAUD) message. In such a format, the Affected PC field is mandatory, and represents the OPC that undergoes state change, the Network Appearance field (which identifies the network appearance of the M3UA protocol) and the INFO String field are optional, and the route keyword index value “Routing Context” appears conditionally. FIG. 8b shows the format of an SCON message, where: the Affected PC field is mandatory and represents the OPC that suffers congestion, the Concerned DPC field is optional and represents the DPC affected by the congestion, the Network Appearance field and the INFO String field are optional, and the Routing Context field appears conditionally. FIG. 8c shows the format of a DUPU message, where: the Affected PC field is mandatory and represents the OPC that suffers unavailable user part, the User/Cause field is mandatory and represents the unavailable user identifier and the cause, the Network Appearance field and the INFO String field are optional, and the Routing Context appears conditionally.

The SS7 system, MTP3 protocol, and M3UA protocol described above reveal that: The M3UA protocol is designed to solve interworking between the SS7 system and the IP-based network, and is implemented by setting an M3UA-based SG.

Currently, for different application scenarios, multiple adaptation-layer protocols such as M3UA, M2PA, M2UA, and SUA are put forward on the signaling network function level. The lower-layer protocol stack of all such protocols is an SCTP/IP. The functions of the M2PA are similar to those of the SS7 MTP2 protocol. The M2UA is a user adaptation protocol between the MTP2 and the MTP3, and the SUA is a user adaptation protocol between the MTP3 and the SCCP. In the mobile field, the M3UA protocol is the most frequently used. The 3GPP R4 puts forward a method for bearing signaling in an IP-based network. The Mobility Management Protocol (MAP), CAMEL Application Protocol (CAP), and Bearer Independent Call Control (BICC) signaling can be carried in an IP-based network.

Generally, in order to construct a large-scale 3GPP R4 network, a network is required to provide signaling routing and transferring. This signaling network may be a traditional SS7 system, or an IP-based network. FIG. 9a, FIG. 9b, and FIG. 9c show three network structures for signaling interworking between an SS7 system and an IP-based network in the conventional art. FIG. 9a shows a single-hop networking scheme where a Signaling End Point over Internet Protocol (IPSEP) in an IP-based network passes through an SG. In this network, the SG interworks with the IPSEP through an M3UA protocol, and the SG interworks with the SEP in the SS7 system through an MTP3 protocol. FIG. 9b shows a multi-hop networking scheme of an SG in an IP-based network. In this network, an SG that interworks with the SS7 system through MTPS, or an SG that interworks with the origination IPSEP through an M3UA protocol, interworks with the destination IPSEP through multiple hops, namely, by spanning at least one SG; the SGs interwork with each other through an M2PA-based MTP3, and the SG interworks with the IPSEP through an M3UA protocol. FIG. 9c shows a single-hop networking scheme of an IPSEP in an IP-based network, namely, the IPSEPs interwork with each other through an M3UA protocol.

Evidently, the networking based on the M3UA protocol is still in the SG-AS model and the peer IP application mode. The M3UA protocol primarily stipulates the application of a single application mode, namely, SG-AS model, and lacks technical stipulation about networking based on the M3UA protocol on the whole. The concept and the operation of the M3UA protocol are primarily intended for the SG, and the M3UA protocol defines how an SG distributes signaling to an AS, and does not clarify or expound how the AS interworks with the SS7 system through more than one SG.

In the process of developing the present invention, the inventor discovers that: In some signaling networks, it is stipulated that the interconnection is based on the M3UA protocol. In this case, it is possible that multiple SG hops are interconnected through the M3UA protocol. However, the M3UA protocol does not stipulate such an application mode, and the SG-AS model or the peer IP application mode defined by the M3UA protocol are not directly applicable. That is, it is impossible to construct a sophisticated M3UA-based network through the M3UA protocol.

The 3GPP stipulates that the MAP, CAP, and BICC can be carried on the basis of an M3UA protocol. Therefore, the M3UA protocol is applied between STPs, and between an STP and an SEP. However, such a scheme is defective. The M3UA is a user adaptation layer protocol. It is primarily responsible for adaptation between layers, and cannot perform signaling network management. Therefore, the upper layer of the MTP3 implements applications, and the low layer of the MTP3 needs no change. From this perspective, it is appropriate for the MAP and the CAP to be carried through an M3UA protocol, but the M3UA protocol is unable to perform multi-hop route management because in its capacity as an inter-STP communication protocol capable of signaling network management.

From the perspective of the application and networking of the M3UA protocol, when the MAP and the CAP are carried based on the M3UA, the M3UA-based signaling network management cannot be routed from the STP to the SEP because the M3UA protocol does not provide signaling network management. Therefore, only the M2PA protocol capable of signaling network management is applicable between STPs. If the SEP is also based on the M2PA protocol, the entire-network MTP3 functions can be accomplished. In this way, the signaling is transmitted over IP, and the incapability of signaling network management in the case of using the M3UA protocol is avoided. However, the 3GPP does not propose use of the M2PA protocol. Therefore, no manufacturer supports such M2PA solutions. Besides, the M2PA protocol for implementing signaling transmission in sophisticated networking still provides no solution to sophisticated M3UA-based networking

To sum up, the conventional art is difficult to set up M3UA-based networking throughout the network, especially, sophisticated M3UA-based networking.

### SUMMARY

A network capable of M3UA-based networking is provided in an embodiment of the present invention. This network implements M3UA-based networking throughout the network.

An apparatus capable of M3UA-based networking is provided in an embodiment of the present invention. This apparatus supports M3UA-based networking throughout the network.

A method for transferring messages in a network capable of M3UA-based networking is provided in an embodiment of the present invention. This method enables transmission of signaling service messages or route management messages in a network capable of M3UA-based networking.

The technical solution under the present invention is implemented in the following way.

A network capable of M3UA-based networking is disclosed herein. This network includes a Signaling End Point (SEP) over Internet Protocol (IP), namely, IPSEP, and a Signaling Transfer Point (STP) over IP, namely, IPSTP.

The IPSTP is configured to perform signaling interworking with an IPSEP and/or other IPSTPs in the network, maintain routes dynamically, and transfer the received signaling.

The IPSEP is configured to perform signaling interworking with the IPSTP.

A network capable of M3UA-based networking is disclosed herein. The network includes: (1) an IPSTP, configured to perform signaling interworking with an SS7 SEP and/or other IPSTPs in the network, and maintain routes dynamically; and (2) an SS7 SEP, configured to perform signaling interworking with the IPSTP.

An IPSTP is disclosed herein. The IPSTP includes: (1) a signal transferring module, configured to receive a signaling service message, and transfer the signaling service message according to the route information maintained by the signaling transferring module; (2) a route management message processing module, configured to transfer the obtained state change information according to the destination address of the signaling service message; and (3) a route state updating module, configured to update the route information according to the obtained state change information.

An IPSEP is disclosed herein. The IPSEP includes: (1) a signaling transceiver module, configured to receive a signaling, and send the signaling according to the route information maintained by the signaling transceiver module; and (2) a route state updating module, configured to update the route information according to the obtained state change information.

A Signaling Gateway (SG) is disclosed herein. The SG includes: (1) a signaling transferring module, configured to: receive an SS7 signaling from an SS7 network system, map the SS7 signaling to an IP domain-based signaling, transfer the IP domain-based signaling according to the route information maintained by the signaling transferring module; or, receive an IP domain-based signaling from an IP-based network, map the IP domain-based signaling to an SS7 signaling, and transfer the IP domain-based signaling according to the route information; (2) a route management message processing module, configured to transfer the obtained state change information according to the destination address of the signaling; and (3) a route state updating module, configured to update the route information according to the obtained state change information.

A method for transmitting signaling service messages in a network capable of M3UA-based networking is disclosed herein. The method enables setting of multi-hop route information corresponding to the route flag. The method includes: (1) receiving an M3UA-based signaling service message; and (2) determining route information according to the route flag carried in the signaling service message, and sending the signaling service message through the determined route.

A method for transmitting signaling management messages in a network capable of M3UA-based networking is disclosed herein. The method enables setting of a multi-hop route. The method includes: updating the set multi-hop route according to the route state change information carried in the received route management message or the route state information obtained through detection.

A method for maintaining a route dynamically is disclosed herein. The method is applicable to a network capable of M3UA-based networking, and includes: (1) obtaining the information about state change of the relevant SP; (2) updating the maintained destination SP and route state information according to the information about state change of the SP; and (3) notifying the information about state change to other relevant SPs.

The foregoing solution reveals that: Through the network, apparatus, and method disclosed herein, signaling network management functions are set in the IPSEP, and a multi-hop M3UA-based network is constructed by using the IPSEP as an STP; and the IPSEP transfers the signaling service message and maintains the route information of the network dynamically. Therefore, the embodiments of the present invention accomplish the M3UA-based networking throughout the network, especially, sophisticated M3UA-based networking.

### BRIEF DESCRIPTION OF THE DRAWINGS

FIG. 1 shows a structure of a conventional signaling network;

FIG. 2 shows the message format defined by the conventional MTP3 protocol;

FIG. 3 shows how a conventional signaling service message is carried in a message format shown in FIG. 2;

FIG. 4 shows how a route management message is carried in a message format shown in FIG. 2 in the conventional art;

FIG. 5 shows a topology of networking based on the M3UA SG-AS mode in the conventional art;

FIG. 6 shows a topology of network based on the peer application mode in the conventional art;

FIG. 7 shows a topology of networking in a typical M3UA SG-AS mode in the conventional art;

FIG. 8a, FIG. 8b and FIG. 8c show the format of the M3UA-based network management messages;

FIG. 9a, FIG. 9b, and FIG. 9c show three network structures for signaling interworking between a SS7 system and an IP-based network in the conventional art;

FIG. 10 shows a network capable of M3UA-based networking in an embodiment of the present invention;

FIG. 11 shows signaling service management performed by an NE over M3UA in an embodiment of the present invention;

FIG. 12 shows a structure of a Concerned DPC field in an embodiment of the present invention;

FIG. 13 shows signaling route management in the first embodiment of the present invention;

FIG. 14 shows signaling route management in the second embodiment of the present invention;

FIG. 15 shows signaling route management in the third embodiment of the present invention;

FIG. 16 shows signaling route management in the fourth embodiment of the present invention;

FIG. 17 shows signaling route management in the fifth embodiment of the present invention;

FIG. 18 shows a first network capable of M3UA-based networking in an embodiment of the present invention;

FIG. 19 shows a second network capable of M3UA-based networking in an embodiment of the present invention;

FIG. 20 shows a third network capable of M3UA-based networking in an embodiment of the present invention;

FIG. 21 shows a fourth network capable of M3UA-based networking in an embodiment of the present invention;

FIG. 22 shows a structure of an IPSTP in an embodiment of the present invention;

FIG. 23 shows a structure of an IPSEP in an embodiment of the present invention;

FIG. 24 shows a structure of an SG in an embodiment of the present invention;

FIG. 25 is a flowchart of a method for transmitting signaling service messages in a network capable of M3UA-based networking in an embodiment of the present invention; and

FIG. 26 is a flowchart of a method for transmitting route management messages in a network capable of M3UA-based networking in an embodiment of the present invention.

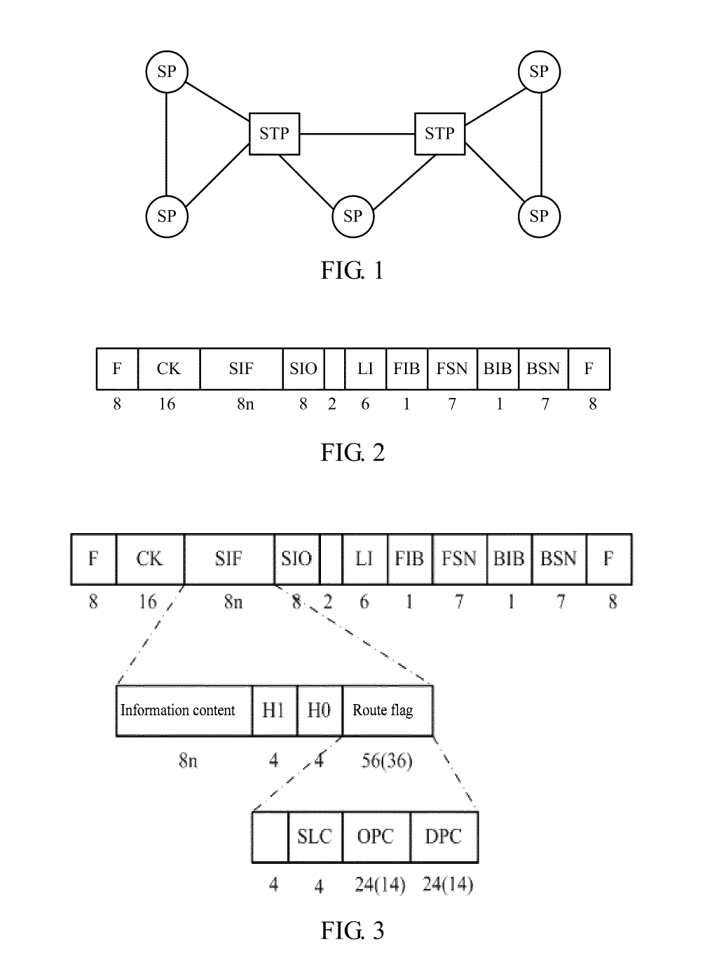

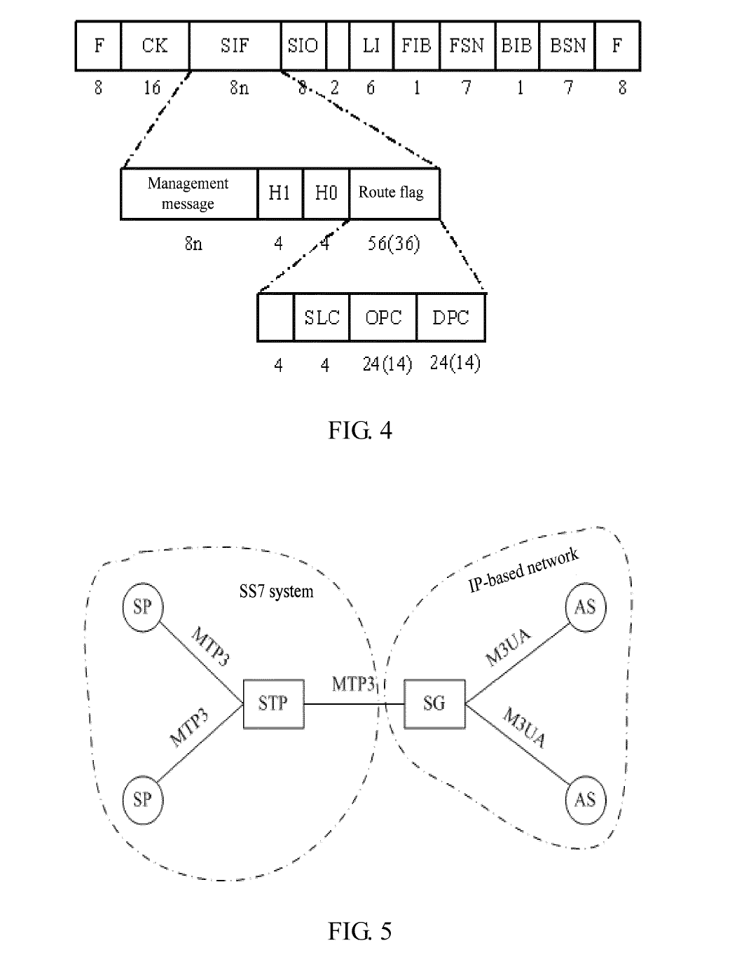

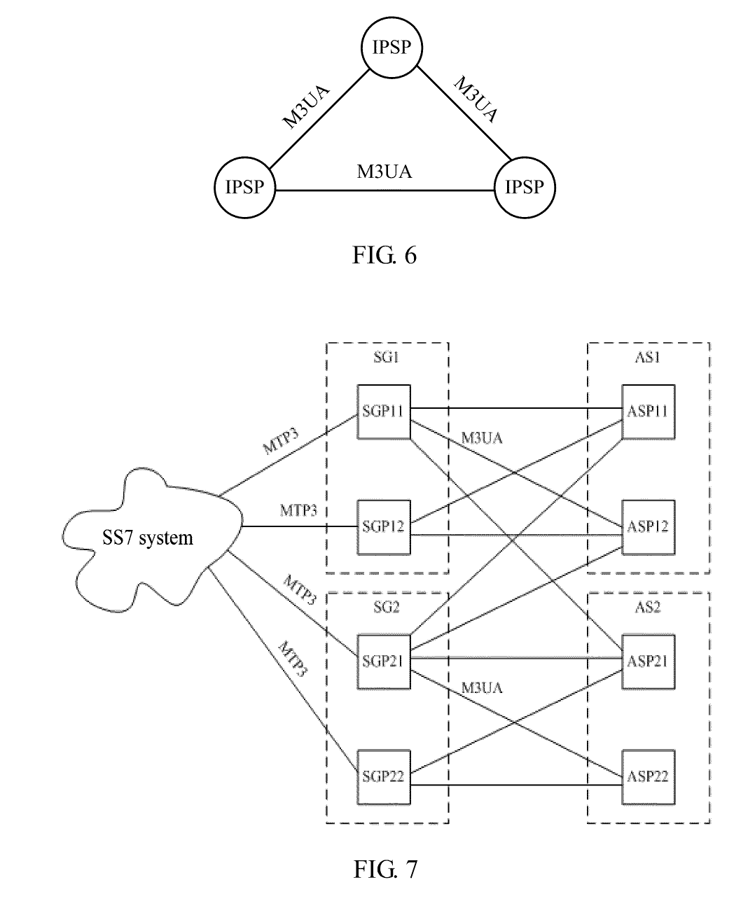

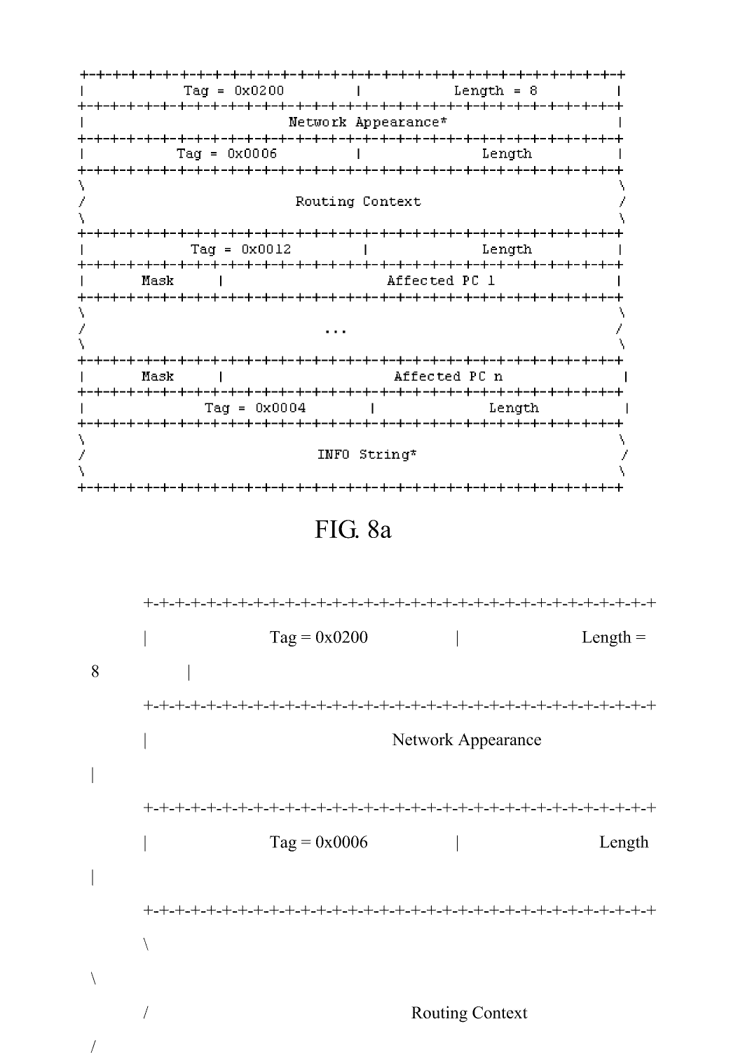

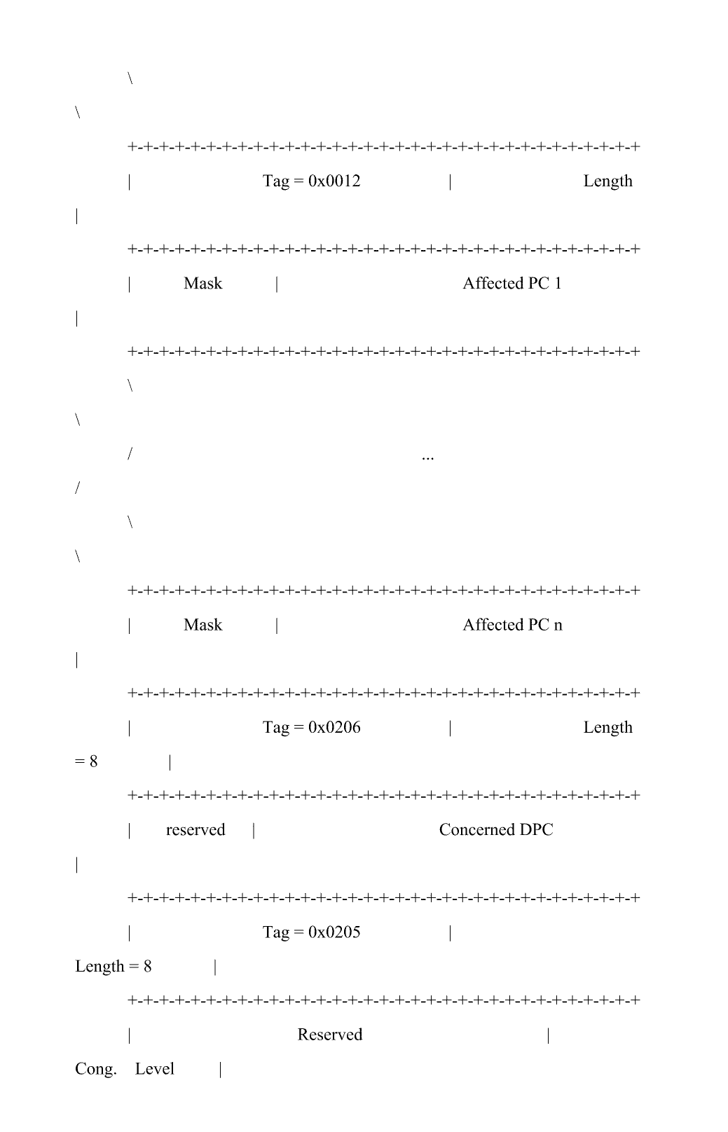

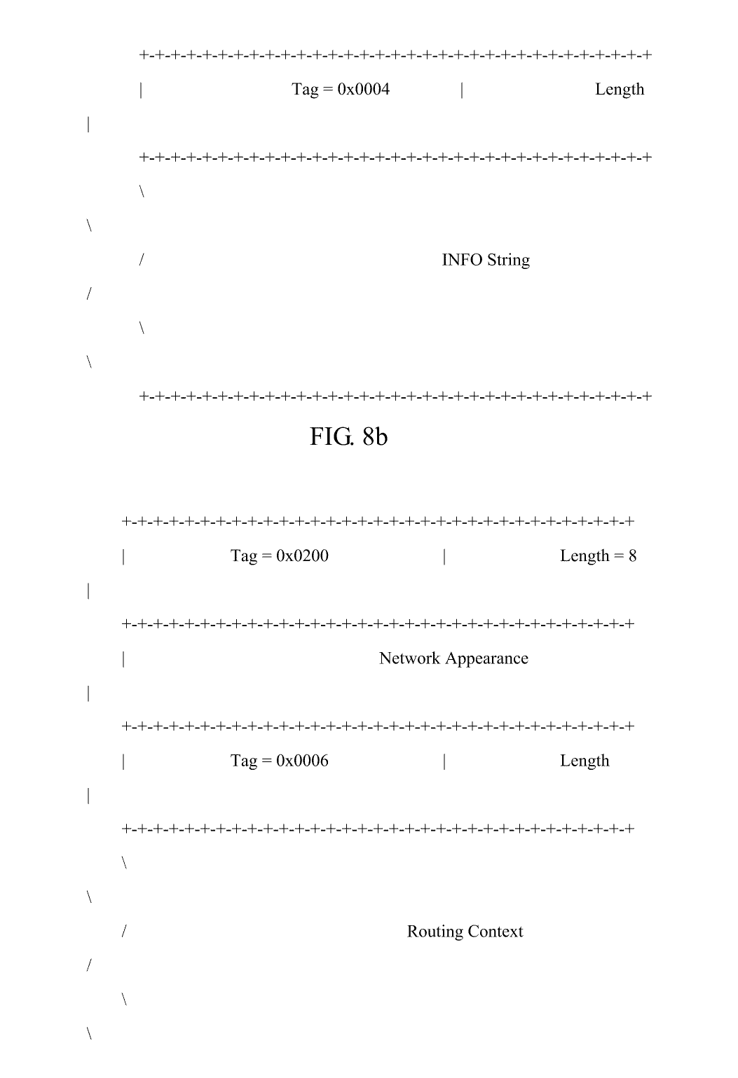

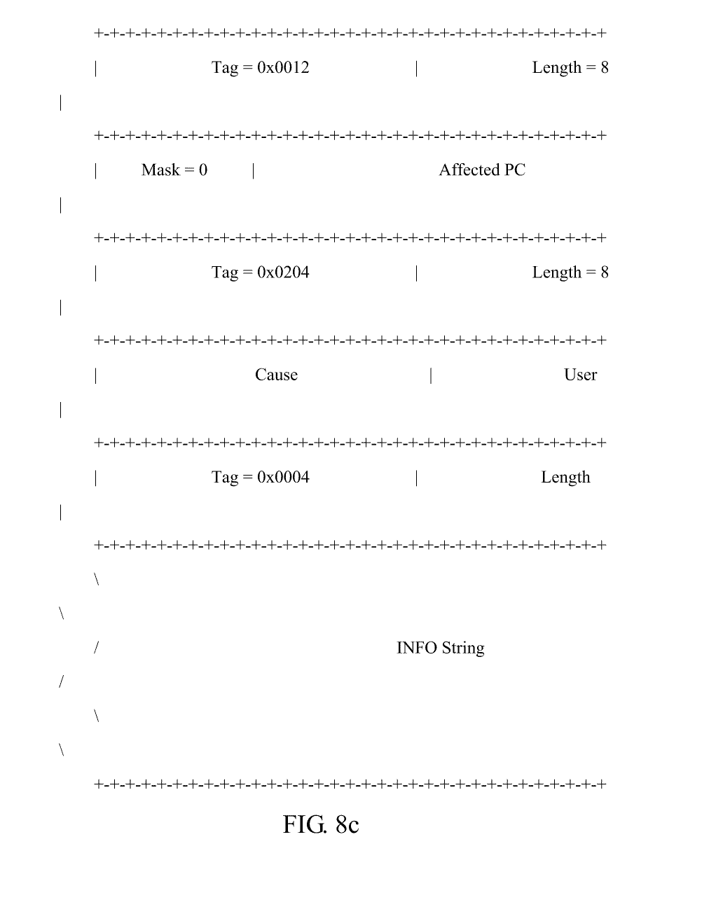

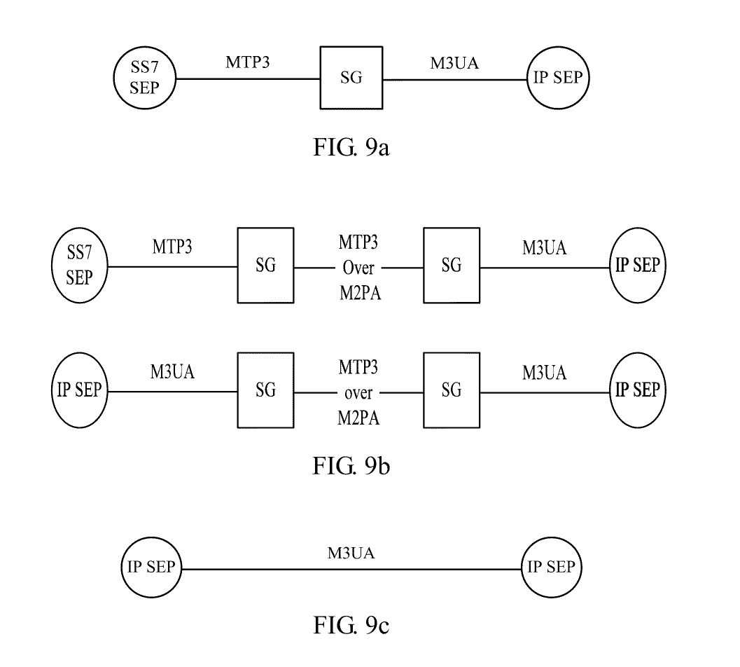

### DETAILED DESCRIPTION

In order to make the technical solution, objectives and merits of the present invention clearer, the present invention is hereinafter described in detail by reference to accompanying drawings and preferred embodiments.

The M3UA protocol is extended herein to support signaling network management. In this way, in the networking based on the M3UA protocol, each NE can bear signaling through the M3UA protocol capable of signaling network management. The M3UA protocol capable of signaling network management may be regarded as extension of the SS7. Its purposes are also to transmit signaling in an IP-based network, namely, transmit the signaling of the origination node to the destination node according to preset route information, and maintain the reliability of the whole IP-based network constructed through the M3UA protocol by means of the signaling network management function.

In order to make the embodiments of the present invention clearer, the following conceptions are described briefly.

According to the M3UA standards “RFC3332” and “RFC4666”, the functions of the M3UA protocol include: (1) SPC identification; (2) routing context and route keywords; (3) interworking between an SS7 and an IP-based network; (4) redundancy model; (5) congestion management; (6) traffic control; (7) Stream Control Transport Protocol (SCTP) stream mapping on the lower layer of the M3UA protocol; and (8) client/server model.

The functions (2) and (3) are closely related to the present invention, and are detailed below:

### (2) Routing Context and Route Keywords

FIG. 7 shows a topology of networking in a typical M3UA SG-AS mode in the conventional art. The M3UA protocol stipulates that an SG is composed of one or more SGPs, and an AS is composed of one or more ASPs. How does an SG send a signaling in the SS7 system to an AS in an IP-based network, and how is a signaling in the AS sent to the SS7 system? An address translation mapping function is defined in the M3UA protocol, and mapping is performed through route keywords to implement such a function. That is, the M3UA protocol performs signaling routing and distribution between the SG and the AS through route keywords. The M3UA protocol stipulates a concept of a route context to represent the index value of the route keyword. In this way, when a relation is set up between the SGP and the ASP, a route context may be carried to represent the route keyword of the route between them. The route keyword of the M3UA protocol combines the fields in the route flag of the signaling as a basis for distribution between the SG and the AS. For example, the signaling from an SS7 system to an AS may need to be processed by different ASs. In this case, the message may be distributed to different ASs for processing according to the combinations such as OPC/DPC/SI in the signaling message.

The route keyword of the M3UA protocol is different from the route concept of the MTP3 protocol. The M3UA route keyword concept exists between the SG and the AS, and is different from the entire-network route concept of the MTPS protocol.

### (3) Interworking Between SS7 and an IP-Based Network

In order to implement interworking between an IP-based network and an SS7 system, the M3UA protocol stipulates several route management messages transmissible in an IP-based network, which correspond to the route management messages in the SS7 system. Such messages are based on the M3UA protocol, as described below:

DUNA message: When a node in the SS7 system fails or is unavailable, the SG sends a DUNA message to the AS. The DUNA message may correspond to the TFP message in the SS7 system.

DAUA message: When a node in the SS7 system recovers from failure and becomes available, the SG sends a DAUA message to the AS. The DAUA message may correspond to the TFA message in the SS7 system.

DAUD message: Through a DAUD message, the AS queries the state of a node in the SS7 system. This message corresponds to the RST message in the SS7 system.

Signaling Congestion (SCON) message: When a node in the SS7 system is congested, the SG sends an SCON message to the NA. The SCON message corresponds to the TFC message in the SS7 system.

Destination User Part Unavailable (DUPU) message: When the upper-layer user part of a node in the SS7 system is unavailable, the SG sends a DUPU message to the AS. The DUPU message corresponds to the UPU message in the SS7 system.

In the networking based on an M3UA protocol capable of signaling network management, depending on the specific NE processing signaling, the NEs are sorted into two types: IPSEP and IPSTP. The IPSEP is configured to receive, send and handle signaling, and the IPSTP is configured to transfer signaling. In the embodiment of the present invention, only the IPSTP is capable of signaling network management. In practice, both IPSTP and IPSEP may be capable of signaling network management. The embodiment of the present invention is capable of not only implementing M3UA-based networking, but also integrating the formed network with the SS7 system and implementing interworking between SS7 SEPs through the M3UA-based SG.

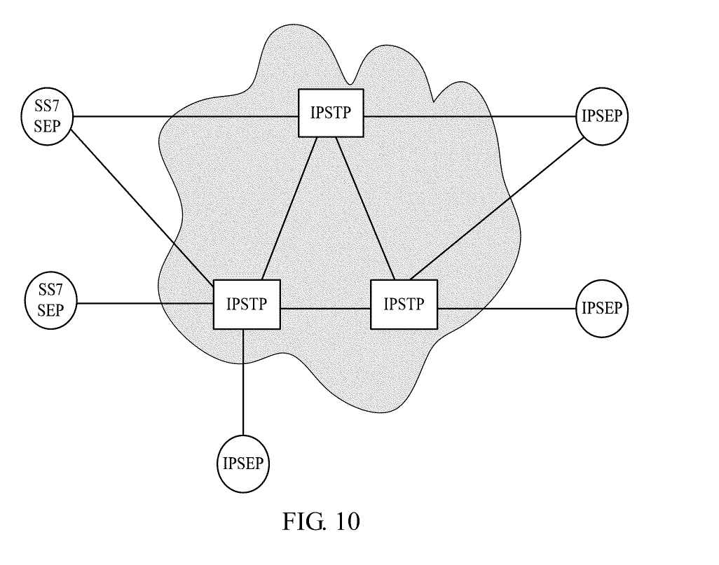

FIG. 10 shows a network capable of M3UA-based networking in an embodiment of the present invention. The network includes at least one IPSTP and at least one IPSEP.

The IPSTP performs signaling interworking with the IPSEP and/or other IPSTPs in the network, and is configured to transfer the received signaling, and perform signaling network management for the IPSEP and/or other IPSTPs under signaling interworking.

The IPSEP performs signaling interworking with the IPSTP, and is configured to receive signaling from the IPSTP, and handle the signaling or send the signaling to the IPSTP.

In the embodiment of the present invention, the IPSTP may also perform signaling interworking with the SS7 network, namely, with the SEP in the SS7 network. This IPSTP also provides the routing context function and the route keyword function of the SG in the conventional art. Conversely, the SG in the conventional art is enhanced to be capable of signaling network management.

In the embodiment of the present invention, the IPSEP may also provide the signaling network management function to perform signaling network management for the IPSEP itself and for the IPSTPs under signaling interworking.

In the embodiment of the present invention, signaling network management includes signaling service management and signaling route management, as detailed below.

### Signaling Service Management

The signaling network management function set in an NE over M3UA in this embodiment is the signaling transfer function. The existing M3UA protocol defines the routing context function and the route keyword function to perform signaling routing and distribution between the SG and the AS (or between the IPSP and the IPSP). After the signaling transfer function is set for the NE over M3UA, the NE needs to handle the signaling transfer service that spans adjacent NEs. Therefore, the concept of route is introduced to deal with the signaling network which spans adjacent NEs.

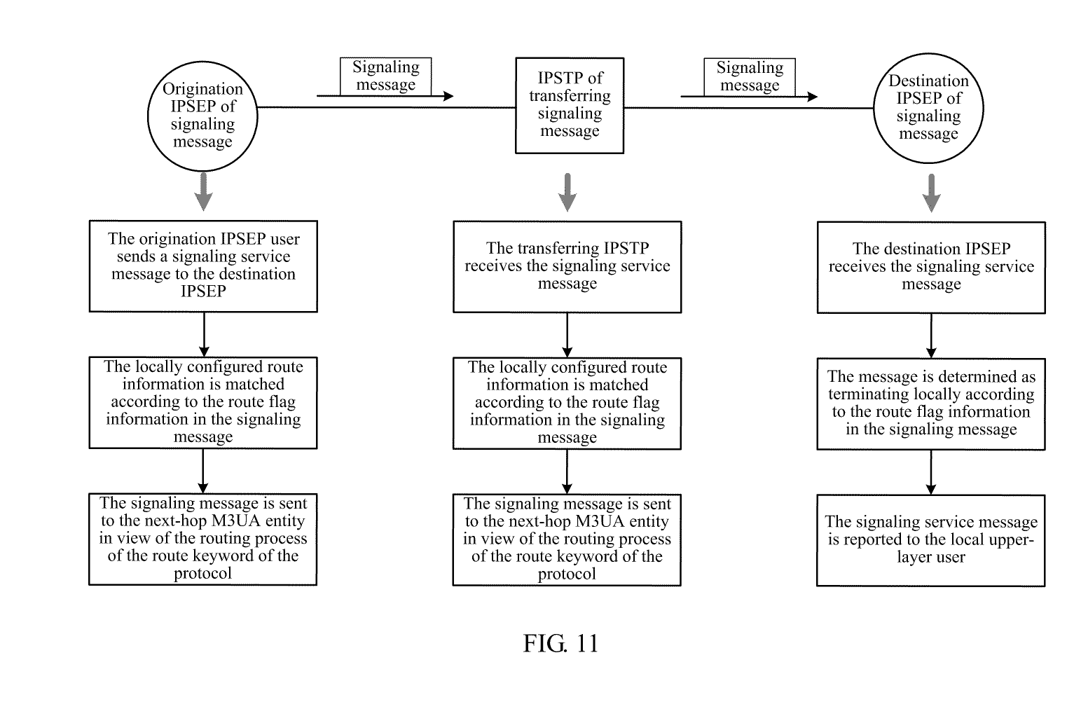

FIG. 11 shows signaling service management performed by an NE over M3UA in an embodiment of the present invention. The signaling service management includes:

The route information corresponding to the route flag is configured on the IPSEP and the IPSTP in a network capable of M3UA-based networking When the IPSEP sends a signaling service message (or briefly called “signaling”), the route information is matched according to the route flag in the signaling service message first, and the signaling service message is sent to the next-hop M3UA protocol entity (IPSEP or IPSTP) in view of the route key processing flow specified in the M3UA protocol. The next-hop M3UA protocol entity also performs the foregoing process until the signaling service message is received by the destination M3UA protocol entity (IPSEP). Afterward, this entity matches the route information according to the route flag carried in the signaling service message, determines the local termination, and reports the signaling service message to the local upper-layer user.

### Signaling Route Management

In the conventional art, the M3UA protocol provides the interworking function of the signaling network management, which is different from the MTP3 signaling network management function of the SS7 system. The interworking function of the signaling network management of the M3UA protocol aims at interworking between an IP-based network and an SS7 network. The messages applied in an IP-based network are primarily the M3UA-based messages such as DUNA and DAVA. Originally, the M3UA protocol is designed for use in an SG to implement the interworking between an IP-based network and an SS7 system. Therefore, if the signaling service message needs to be transferred, the M3UA protocol is functionally deficient. In order to fulfill the M3UA-based networking and ensure reliability of the signaling network after networking, the signaling route management of the M3UA protocol is enhanced in the embodiment of the present invention, as described below:

### (1) The Route Management Message Transmitted in an IP-Based Network is Extended.

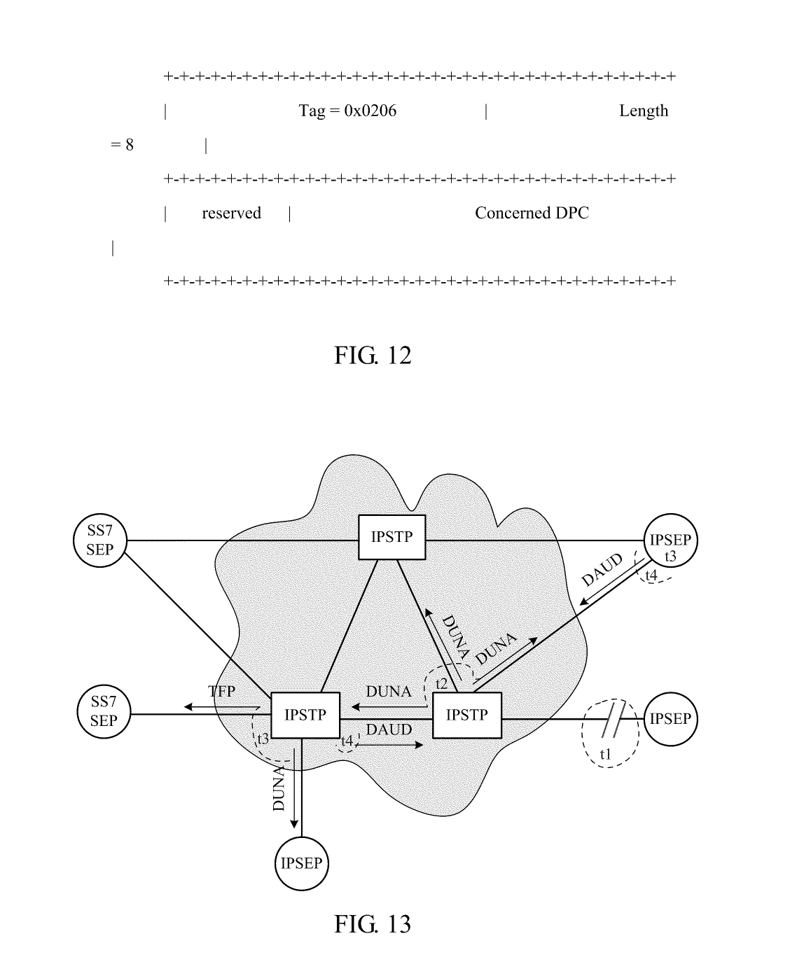

The route management message of the M3UA protocol in the conventional art is applicable only to the adjacent-hop M3UA entity, namely, only to notifying the signaling state about an M3UA protocol entity to an adjacent M3UA protocol entity. The route management message of the M3UA protocol is extended in the embodiment of the present invention. That is, a Concerned DPC field is added into the existing DUNA/DAVA/DAUD/DUPU field to indicate the origination SP that sends the route management message. The origination SP is generally identified by an OPC. In this way, the M3UA protocol entity that receives such a message subsequently (including the IPSTP and the IPSEP that transfer the message subsequently) may determine the origination M3UA protocol entity which sends the message according to the Concerned DPC field. As shown in FIG. 12, the format of the Concerned DPC field includes: a tag, length of the field, and reserved bits.

In this embodiment, the tag may be defined as compatible with the Concerned DPC field in the SCON message. Nevertheless, a new tag may be defined. At the time of transferring a service signaling message, the Concerned DPC field needs to be presented. When the Concerned DPC field in this message is compatible with the Concerned DPC field in the SCON message, the Concerned DPC field in the SCON message is mandatory.

In this embodiment, the Concerned DPC field may also be set in other messages. Alternatively, another message is set to perform similar functions, for example, a new Tag field is added or a domain value is added to another existing field such as INFO String.

### (2) The Detailed Process of Implementing Signaling Route Management is as Follows.

FIG. 13 shows signaling route management in the first embodiment of the present invention. Supposing that the sequence of sending the service signaling message is t1-t2-t3-t4 and the signaling link at point t1 is disconnected, the process of handling the signaling link fault is as follows:

First, when the IPSTP at t2 detects failure of receiving the service signaling message of the IPSEP at t1, the IPSTP determines that t1 is faulty, and notifies the fault information to other relevant M3UA protocol entities (namely, IPSTP at t3 and IPSEP at t4 in FIG. 13) immediately through an extended DUNA message (or through a TFP message of the MTP3 if the notified SP is an NE of the SS7 system). The relevant M3UA protocol entities are the entities in a signaling service relation with t1. Meanwhile, the IPSTP updates the maintained route state information and SP information about t1.

Secondly, after receiving the DUNA message, the IPSTP at t3 determines the faulty M3UA protocol entity (namely, IPSEP at t1) according to the origination SP, updates the maintained route state information and SP information about t1, and starts a timer to detect the state of t1 periodically. That is, the IPSTP sends an extended DAUD message to the IPSEP at t1 periodically, checks whether the IPSEP makes a response and receives the response content, and determines whether IPSEP is faulty.

After receiving the extended DAUD message, the IPSEP at t1 may send its own state as a response to the IPSTP at t3 through t2 by means of a DUNA message (the fault persists) or a DAVA message (the fault is cleared).

When the IPSTP is a signaling transfer point, the received DUNA message needs to be further sent to other relevant SPs (in a signaling service relation with the faulty SP) if the locally maintained destination SP state changes from non-fault to fault. If the locally maintained destination SP state is already a faulty state, no processing is required.

The foregoing process is applicable to all other IPSTPs or IPSEPs (including the IPSTPs at t2 and t4).

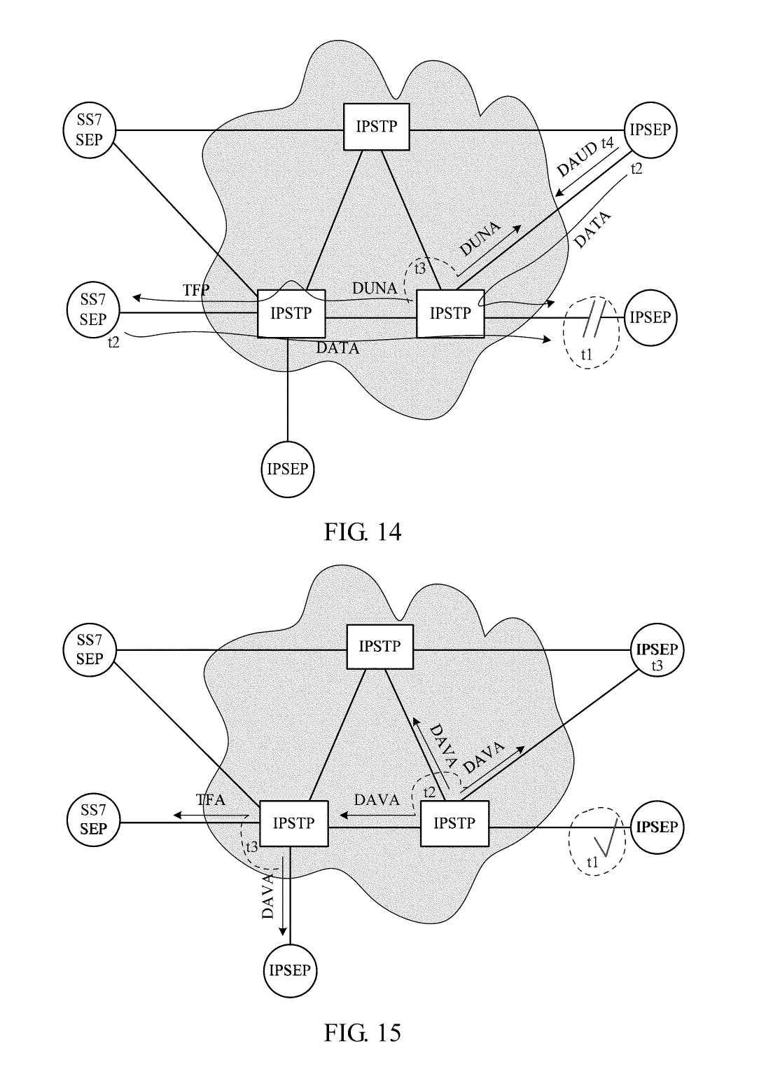

FIG. 14 shows signaling route management in the second embodiment of the present invention. Supposing that the sequence of sending the service signaling message is t1-t2-t3-t4 and the signaling link at t1 is disconnected, the process of handling the signaling link fault is as follows:

First, the IPSEP at t1 has maintained the SP route state according to the flowchart in FIG. 13.

Secondly, the SS7 SEP at t2 sends a signaling service message to the IPSEP at t1. The message needs to be transferred by the IPSTP, namely, by the IPSTP at t3.

Afterward, when the IPSTP at t3 transfers the signaling service message to the IPSEP at t1, the IPSTP knows that the IPSEP at t1 is already faulty according to the maintained route state information and SP information, and therefore, discards the signaling service message and sends the fault information to the relevant SPs immediately (including SS7 SEP at t1 and IPSEP at t2) through an extended DUNA message directly (or through a TFP message of the MTP3 if the notified SP is an SS7 SEP), indicating that the IPSEP at t1 is faulty.

Finally, the relevant SPs (including SS7 SEP at t1 and IPSEP at t2) that receive the extended DUNA message or TFP message perform the t3 operations shown in FIG. 13.

FIG. 15 shows signaling route management in the third embodiment of the present invention. Supposing that the sequence of sending the service signaling message is t1-t2-t3 and the signaling link at t1 recovers from disconnection, the process of handling the signaling link fault is as follows:

First, after the IPSTP at t2 performs t3 operations shown in FIG. 13, the IPSTP detects that the IPSEP at t1 recovers from failure, and therefore, notifies a recovery message to the relevant SPs in the network (including IPSTP and IPSEP at t3) through an extended DAVA message (or through a TFA message if the notified SP is an SS7 SEP in the SS7 system), and updates the maintained route state information and SP information of t1.

Secondly, the SP that receives the DAVA message or TFA message updates the maintained route state information and SP information of t1, and stops the process of detecting recovery of the IPSEP at t1 periodically in the troubleshooting steps 1 and 2.

Finally, when the IPSTP is a signaling transfer point, the recovery information needs to be further sent to other relevant SPs (in a signaling service relation with the faulty SP) if the locally maintained state of the IPSEP at t1 changes from fault to recovery. If the locally maintained state of the IPSEP at t1 is already a recovery state, no processing is required.

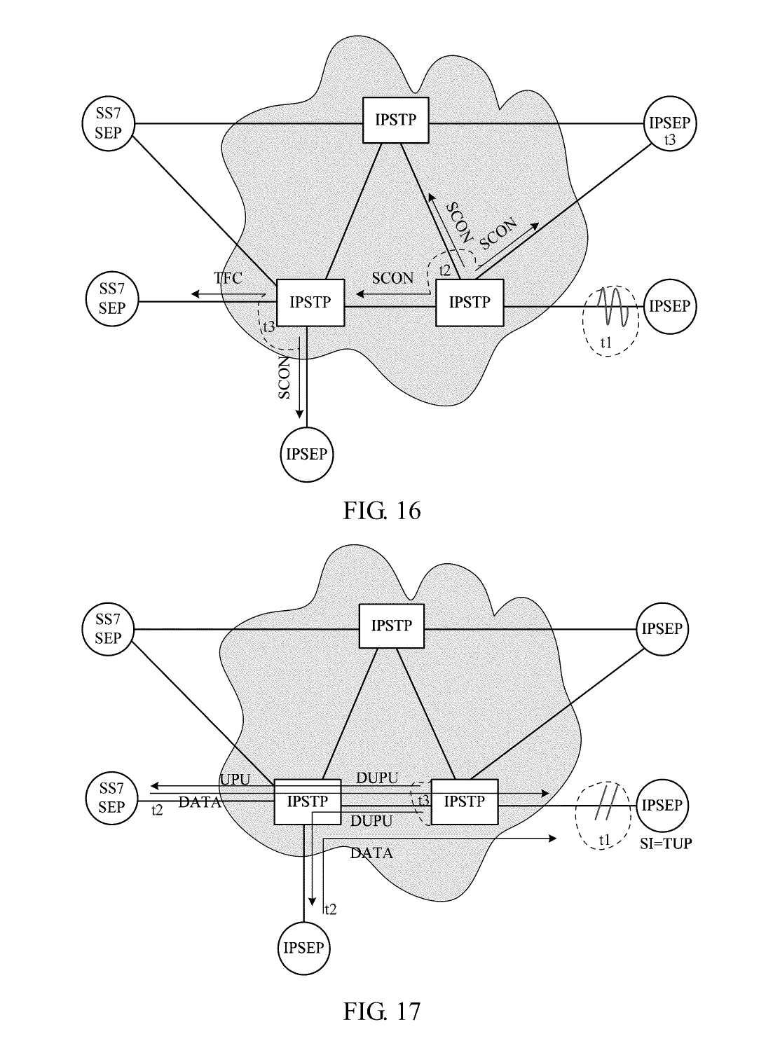

FIG. 16 shows signaling route management in the fourth embodiment of the present invention. Supposing that the sequence of sending the service signaling message is t1-t2-t3 and the signaling link at t1 is congested, the process of handling the signaling link fault is as follows:

First, when the IPSTP at t2 detects that the IPSEP at t1 is congested, the IPSTP notifies the congestion information to other relevant SPs (in a signaling service relation with the IPSEP at t1, including IPSEP and IPSTP at t3) through an extended SCON message (or through a TFC message of MTP3 if the notified SP is an SS7 SEP).

Secondly, other relevant SPs that receive the SCON message update the maintained IPSEP route state information and SP information of t1, and control the traffic of the signaling service messages sent to the IPSEP at t1.

When the IPSTP at t3 is a signaling transfer point, the IPSTP also needs to notify the change of the congestion state to other relevant SPs through an extended DAVA message if the maintained state information of the congested destination SP has changed.

In this embodiment, when the IPSTP receives a message from an origination SP and transfers the message to a destination SP, if the destination SP is congested, the IPSTP needs to notify the congestion state information to the origination SP immediately (or when the set congestion policy is fulfilled, for example, when the N message is received). Therefore, the origination SP controls the signaling service traffic and reduces the signaling service messages sent through this route to the destination SP.

FIG. 17 shows signaling route management in the fifth embodiment of the present invention. Supposing that the sequence of sending the service signaling message is t1-t2-t3 and the upper-layer user part of the IPSEP is unavailable, the process of handling the signaling link fault is as follows:

First, the IPSTP at t3 detects that the upper-layer user part of the IPSEP is unavailable. At this time, the route keyword corresponding to the IPSEP at t1 is a specific upper-layer user part SI, for example, SI=TUP user.

Optionally, when the IPSTP detects that an IPSEP representative of a user part is faulty, the IPSTP needs to notify the information about unavailability of the upper-layer user to other relevant SPs (in a signaling service relation with the IPSEP) through an extended DUPU message. Therefore, the relevant SPs stop sending signaling service messages to the destination IPSEP.

Secondly, when the IPSTP transfers an origination SP message to an IPSEP representative of the upper-layer user part, if the IPSTP discovers that the destination IPSEP is unavailable, the IPSTP needs to notify the information about unavailability of the upper-layer user to the origination SP of the message directly through an extended DUPU message (or through a UPU message of MTP3 if the notified SP is an SS7 SEP). Therefore, the upper-layer user of the origination SP stops sending signaling messages to the destination IPSEP.

If the networking is based on the M3UA protocol, each IPSTP in the networking is capable of signaling route management, and is thus able to: (1) detect change of the route state of the surrounding IPSEP, update the maintained route state change and SP change information, and notify other relevant IPSTPs or IPSEPs through an extended route management message; (2) update the maintained route state change and SP change information according to the received state change information and SP information, and notify other relevant IPSTPs or IPSEPs through an extended route management message; (3) notify the fault information to the origination SP of a received signaling service message through an extended route management message if detecting that the maintained destination SP is faulty when transferring the received signaling service message; and (4) start the corresponding route detection process to check for recovery of the route periodically after receiving an extended route management message about fault of an M3UA protocol entity.

In this embodiment, the IPSEP is able to: (1) update the maintained route state after receiving a route management message about route failure or route congestion, and start a route detection process to check for recovery of the route periodically; (2) notify the detected state change to the relevant SPs, for example, notify the information about unavailability of the upper-layer user part to the relevant SPs through an extended DUPU message after detecting the unavailability, or notify the congestion information to the relevant SPs through an extended SCON message after detecting the congestion, or notify the fault to the relevant SPs through a DUNA message after detecting the fault; and (3) notify information about unavailability or congestion to the origination SP of a signaling service message through a DUPU message or an SCON message if discovering that the upper-layer user part is unavailable or detecting congestion after receiving the signaling service message.

With the foregoing technical solution, the M3UA-based networking can be implemented. Given below are several networking examples.

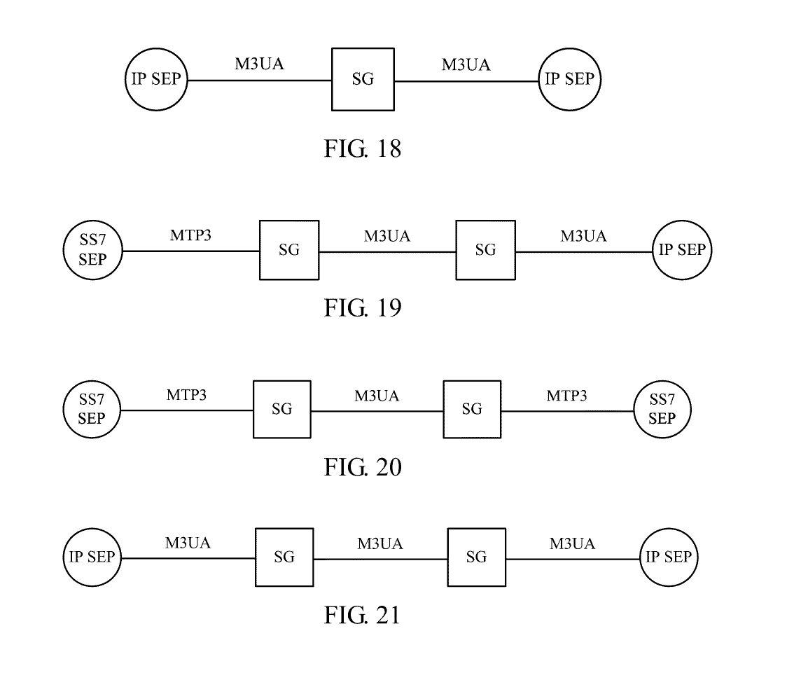

FIG. 18 shows a first network capable of M3UA-based networking in an embodiment of the present invention. It shows how to implement M3UA-based networking through one hop: The SG capable of signaling network management implements signaling interworking between two IPSEPs. This network may perform dynamic route management according to the flowchart in FIG. 13-FIG. 17.

FIG. 19 shows a second network capable of M3UA-based networking in an embodiment of the present invention. It shows the first M3UA-based networking implemented through multiple hops. The SS7 SEP performs signaling interaction with the IPSEP through two hops of SG capable of signaling network management. The SS7 SEP performs signaling interaction with the first hop of SG through an MTP3 protocol. Signaling is transferred between the first hop of SG and the second hop of SG through an M3UA protocol, and signaling is transferred between the second hop of SG and the IPSEP through the M3UA protocol. This network may perform dynamic route management according to the flowchart in FIG. 13-FIG. 17.

FIG. 20 shows a third network capable of M3UA-based networking in an embodiment of the present invention. It shows the second M3UA-based networking implemented through multiple hops. Signaling interaction is performed between the SS7 SEP and the other SS7 SEP through two hops of SG capable of signaling network management, signaling is transferred between the SG and the SS7 SEP or the other SS7 SEP through an MTP3 protocol, and signaling is transferred between the two hops of SG through an M3UA protocol. The IPSTP is configured to: perform signaling interworking with an SS7 SEP and/or other IPSTPs in the network, and maintain routes dynamically. The SS7 SEP is configured to perform signaling interworking with the IPSTP. This network may perform dynamic route management according to the flowchart in FIG. 13-FIG. 17. During the dynamic management, the IPSTP can detect the fault, recovery and congestion states of the SS7 SEP.

FIG. 21 shows a fourth network capable of M3UA-based networking in an embodiment of the present invention. It shows the third M3UA-based networking implemented through multiple hops. Signaling interaction is performed between the IPSEP and the other IPSEP through two hops of SG capable of signaling network management, signaling interaction is performed between the SG and the IPSEP or the other IPSEP through an M3UA protocol, and signaling is transferred between the two hops of SG through the M3UA protocol. This network may perform dynamic route management according to the flowchart in FIG. 13-FIG. 17.

The two apparatuses IPSTP and IPSEP applied in the M3UA-based networking under the present invention are described below.

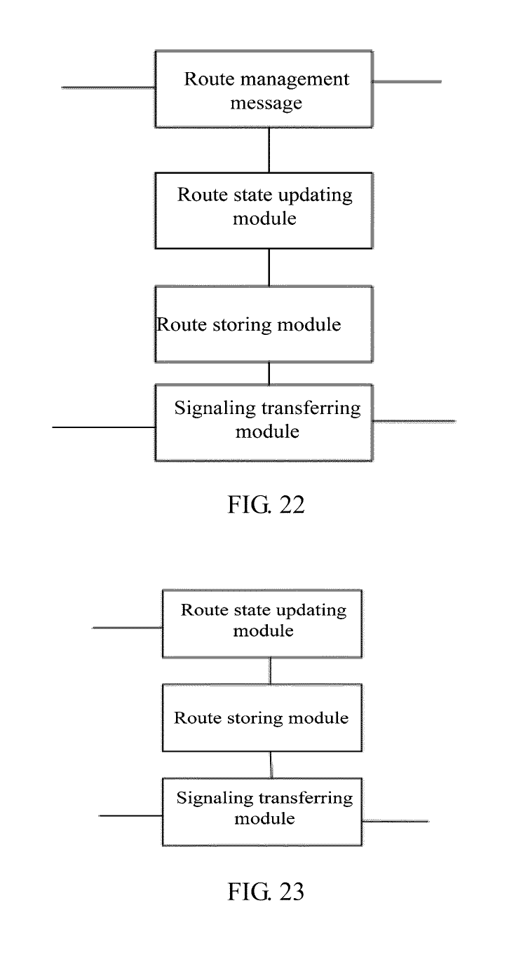

FIG. 22 shows a structure of an IPSTP in an embodiment of the present invention. The IPSTP includes: (1) a signal transferring module, configured to: receive a signaling service message, and transfer the signaling service message according to the route information; (2) a route management message processing module, configured to transfer route management messages; and (3) a route state updating module, configured to update the route according to the route management message obtained from the route management message processing module.

In this embodiment, the IPSTP may further include: a route storing module, configured to store routes.

In this embodiment, this apparatus may further include: (1) a detecting module, configured to send the state information of the route and/or SP to the first route state updating module and the route management message processing module after detecting state change of the route and/or the SP; and (2) a first route state updating module, configured to update the routes stored in the route storing module according to the received state information of the route and/or SP.

In this embodiment, the route management message processing module is the first route management message processing module, which is configured to generate a route management message according to the state information obtained from the detecting module or receive a route management message.

In this embodiment, update of the route is actually update of the route state information and the relevant SP information.

The IPSTP under the present invention includes: (1) a signal transferring module, configured to receive a signaling service message, and transfer the signaling service message according to the route information; (2) a route management message processing module, configured to transfer the obtained SP state change information, for example, through a signaling management message; and (3) a route state updating module, configured to update the route information according to the obtained SP state change information, where the SP state change information may be obtained by receiving the SP state change information, or by detecting change of the state of the relevant SP, or by other means.

In an embodiment, the route management message processing module is the first route management message processing module, which is configured to transfer the received SP state change information.

The route state updating module is the first route state updating module, which is configured to update the route information according to the received SP state change information.

In another embodiment, the IPSTP further includes a detecting module, configured to detect change of the state of the route and/or SP and output the SP state change information. That is, the route management message processing module is the second route management message processing module, which is configured to transfer the SP state change information output by the detecting module.

The route state updating module is the second route state updating module, which is configured to update the route information according to the SP state change information output by the detecting module.

FIG. 23 shows a structure of an IPSEP in an embodiment of the present invention. The IPSEP includes: (1) a signal transceiver module, configured to receive a signaling service message, and send the signaling service message according to the route information; and (2) a route state updating module, configured to update the route information according to the received route management message.

In this embodiment, the IPSEP may further include a route storing module, which is configured to store routes.

In this embodiment, when the IPSEP is capable of signaling network management, the IPSEP may further include: (1) a detecting module, configured to send the changed state information of the route and/or SP to the first route state updating module and the route management message processing module after detecting state change of the route and/or the SP; (2) a route management message processing module, configured to generate and send a route management message according to the state information sent by the detecting module; and (3) a first route state updating module, configured to update the route stored in the route storing module according to the state information received from the detecting module.

In this embodiment, update of the route is actually update of the route state information and the relevant SP information.

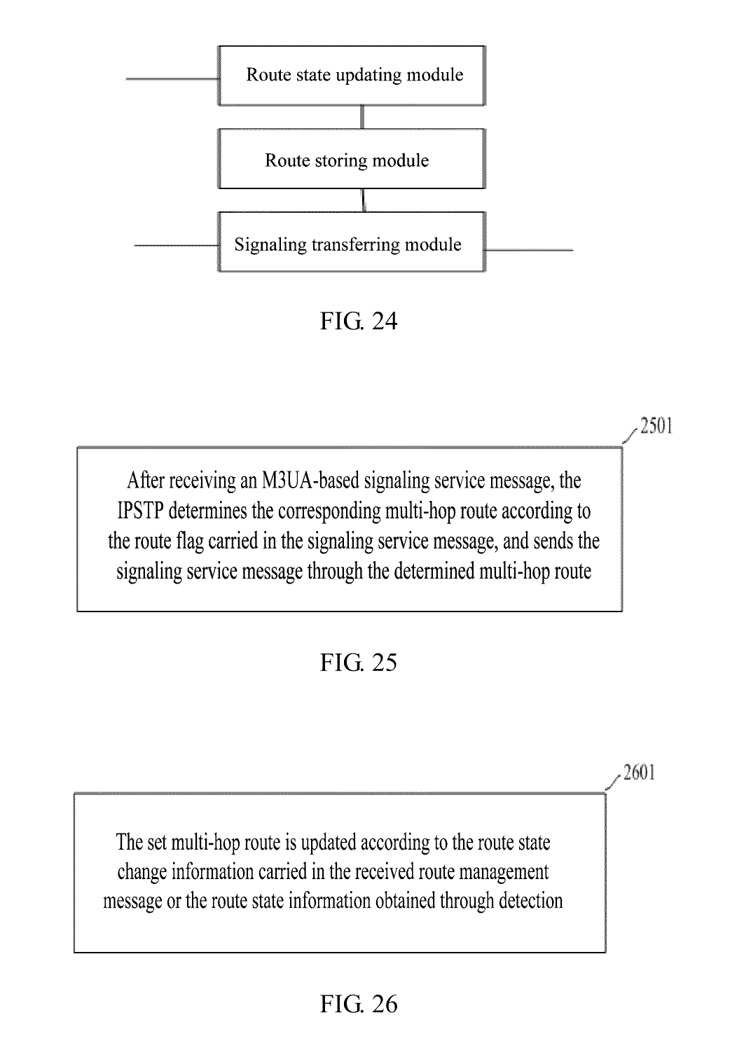

FIG. 24 shows a structure of an SG in an embodiment of the present invention. This SG enhances functions, and is capable of not only transferring signaling service messages, but also signaling network management. The SG includes: (1) a signaling transferring module, configured to: receive an SS7 signaling from an SS7 network system, map the SS7 signaling to an IP domain-based signaling, and transfer the IP domain-based signaling according to the route information; or, receive an IP domain-based signaling from an IP-based network, map the IP domain-based signaling to an SS7 signaling, and transfer the IP domain-based signaling according to the route information; (2) a route management message processing module, configured to transfer route management messages; and (3) a route state updating module, configured to update the route according to the route management message obtained from the route management message processing module.

In this embodiment, the IPSEP may further include a route storing module, which is configured to store routes.

In this embodiment, the apparatus may further include: (1) a detecting module, configured to send the state information of the route and/or SP to the first route state updating module and the route management message processing module after detecting state change of the route and/or the SP; and (2) a first route state updating module, configured to update the routes stored in the route storing module according to the received state information of the route and/or SP.

In this embodiment, the route management message processing module is the first route management message processing module, which is configured to generate a route management message according to the state information obtained from the detecting module or receive a route management message.

A method for transmitting signaling service messages in a network capable of M3UA-based networking is also disclosed in an embodiment of the present invention. FIG. 25 is a flowchart of a method for transmitting signaling service messages in a network capable of M3UA-based networking in an embodiment of the present invention. The method enables setting of a route corresponding to the route flag in an IPSTP. The method includes the following steps:

Step 2501: After receiving an M3UA-based signaling service message, the IPSTP determines the corresponding route according to the route flag carried in the signaling service message, and sends the signaling service message through the determined route.

Alternatively, in this embodiment, a multi-hop route corresponding to the route flag is set in an IPSEP. After receiving a signaling service message, the IPSEP judges whether the message is terminated at the IPSEP itself. If the message is terminated at the IPSEP itself, the IPSEP sends the message to the local upper-layer user.

Alternatively, the IPSEP may construct a signaling service message that carries a route flag according to the multi-hop route set in the IPSEP, and send the message.

In this embodiment, the IPSTP may also translate the SS7 signaling received from the SS7 system to an IP-based signaling, and translate the address to obtain a route flag.

In this embodiment, when the IPSTP transfers a signaling, the IPSTP may query the preconfigured matching route information according to the route flag carried in the signaling, and handle the signaling through the route keyword stipulated in the M3UA protocol and transfer the signaling.

A method for transmitting route management messages in a network capable of M3UA-based networking is also disclosed in an embodiment of the present invention. FIG. 26 is a flowchart of a method for transmitting route management messages in a network capable of M3UA-based networking in an embodiment of the present invention. The method enables setting of a multi-hop route corresponding to the route flag in an IPSTP or IPSEP. The method includes the following steps:

Step 2601: The set multi-hop route is updated according to the route state change information carried in the received route management message or the route state information obtained through detection.

In this embodiment, the route is managed dynamically. After a node receives a route management message from other SPs, the node changes the state information of its own route. When the node detects that the state of the route and/or the SP has changed, the node changes the state information of its own route and/or relevant SPs, and generates a route management message and sends the message to the relevant SPs (which may be determined according to the relevant SPs stored).

In order to let the route management message specify the origination SP, the route management message is extended to carry an OPC.

In this embodiment, the extended route management messages include: DUNA message, DAVA message, DAUD message, and SCON message.

In transferring a signaling, the IPSTP may transfer the signaling to the SS7 SEP in the SS7 system through an MTP3 protocol. When maintaining the route information dynamically, the IPSTP may send the relevant route management message (based on the MTP3 protocol, including: TFP, TFA, TFR, or TFC) to the SS7 SEP in the SS7 system for processing.

The IPSEP in a network capable of M3UA-based networking receives and sends signaling according to the set route information. The IPSEP may also set the signaling network management function, and maintain the set route information dynamically.

In this embodiment, considering that the M3UA-based networking currently involves a moderate number of hops, the following simplified method of signaling network management may be applied in order to be compatible with the existing M3UA protocol entities.

When the IPSTP or the SG that enhances the embodiment of the present invention detects change of the state of the route and/or SP, the IPSTP or the SG notifies the state change to the relevant SPs (which are in a service relation with the route in a changed state).

When the node that receives the route state change notification is an IPSTP, if the route state information maintained by the IPSTP has changed, the IPSTP updates the maintained route state and SP state. When the route state change is changed by SP failure, recovery, or unavailability or congestion of the upper-layer user, the IPSTP further notifies the state information to other relevant SPs through a DUNA, DAVA, DUPU, or SCON message (or through a TFP, TFA, or TFC message if the notified SP is an SS7 SEP); otherwise, no processing is required.

When the node that receives the route state change notification is an IPSEP, if the route state information maintained by the IPSEP has changed, the IPSEP changes the maintained route.

The format of the route management message is the same as that in the original M3UA protocol, thus ensuring compatibility and interworking.

Such a simplified method of signaling network management supports the IPSTP to transfer signaling, and accomplishes the reliable management of the signaling network as far as possible. For the SPs that are implemented according to the original M3UA protocol and do not support signaling transfer or route state maintenance, the loss is only the reliability of the signaling network. Therefore, the best-effort networking application of the signaling network is accomplished, and the compatibility and interworking with the devices in other signaling systems are maintained.

In this embodiment, in order to prevent storms of signaling service messages or route management messages caused by configuration or SP defects in a sophisticated M3UA-based network, the M3UA protocol may be extended to improve the reliability of the whole network capable of M3UA-based networking.

(1) A universal extended field such as a Tag field is added into the M3UA-based signaling or route management message to extend the protocol. In order to keep SPs of different manufacturers compatible and interworking with this extension, the SP may ignore this extended field if the received extended field is unidentifiable to the SP.

Besides, different subtypes and a compatibility identifier indicating whether the field must be identified may be defined in the universal extended field as required. When the SP receives an unidentifiable extended field which carries the compatibility identifier, the network may stop processing the signaling or route management message that carries the universal extended field, and return a failure message to the peer SP, indicating that the message is unidentifiable; or the network may ignore the universal extended field and go on processing.

When the received signaling or route management message that carries the universal extended field needs to be transferred or broadcast to the relevant SPs, the SP that receives the message needs to transfer or broadcast the universal extended field transparently to subsequent SPs. Meanwhile, each hop of SP may add its own universal extended field.

In this embodiment, the universal extended field may be a field in an existing message, for example, the universal extended field may be added into the “INFO String” field of the existing message, or a new Tag is added to define the universal extended field.

(2) The universal extended field helps avoid storms of the route management or signaling service messages as a result of networking or other factors. For example, a universal extended field is added into the route management message, and, when the SG or IPSTP broadcasts the route management message, its own SPC is set into the universal extended field as broadcast path information. In this way, when the SP receives the route management message again, the SP knows that the message has been received according to the universal extended field and then discards the message. In this way, the storm of signaling or route management messages is eliminated.

Besides, similar methods may be applied in the process of transferring the signaling service message. At the time of sending a signaling, the message path information of the STP is added to the signaling to prevent message loop and storms.

(3) In order to eliminate signaling storms, a hop counter may be introduced. That is, a TTL hop counter is added into the universal extended field of the signaling or route management message. Every time when the message is transferred by an SP or broadcast by a signaling network, the counter decreases (for example, decreases by 1) until the TTL hop counter is 0, whereupon the message is discarded.

In this embodiment, (2) and (3) may be used together.

In this embodiment, the method of avoiding the storm or loop and improving the reliability of the whole network capable of M3UA-based networking may be used together with the networking method of M3UA-based networking or the simplified method of M3UA-based networking Especially when such a method is used together with the simplified method of M3UA-based networking, the method not only provides sophisticated signaling networking on the basis of being compatible with the existing M3UA-based networking, but also improves reliability of the signaling network.

It is understandable to those skilled in the art that all or part of the steps of the foregoing embodiments may be implemented by hardware instructed by a program. The program may be stored in a computer-readable storage medium. Once being executed, the program performs one step or a combination of the steps of the embodiments.

In each embodiment of the present invention, the functional units may be integrated into one processing module, or exist independently of each other, or two or more of units are integrated in one module. The integrated module may be in the form of hardware or software modules. The integrated module may be stored in a computer-readable storage medium if the module is implemented in the form of software module and sold and applied independently.

The storage medium may be a Read-Only Memory (ROM), a magnetic disk, or a compact disk.

To sum up, the network, the apparatus, and the method of M3UA-based networking disclosed herein meet the requirements of sophisticated M3UA-based networking perfectly, inherit the application mode of the traditional SS7 system with respect to concepts and usage habits, provide easy networking and operation maintenance management, try to be compatible with the application mode of the existing M3UA-based networking, impose little change or impact on the existing M3UA protocol application, prevent the storm or loop of signaling or route management messages in the signaling network as a result of configuration or SP defects, and enhance the robustness and reliability of the signaling network.

What is claimed is:

1. A network system capable of M3UA-based networking, comprising:
a Signaling End Point over Internet Protocol (IP SEP), and a Signaling Transfer Point over Internet Protocol (IP STP), wherein:
the IPSTP is configured to perform signaling interworking with an IPSEP or other IPSTPs in the network, maintain routes dynamically, and transfer the received signaling; and
the IPSEP is configured to perform signaling interworking with the IPSTP.

2. The network system of claim 1, further comprising:
a Signaling System No.7 Signaling Transfer Point (SS7 STP), the SS7 STP is configured to perform signaling interworking with the IPSTP.

3. The network system of claim 1, wherein:
the IPSTP is further configured to detect change of a route state of the surrounding IPSEP, update maintained route state and SP change information, and notify other relevant IPSTPs or IPSEPs through an extended route management message.

4. The network system of claim 1, wherein:
the IPSTP is further configured to update the maintained route state change and Signaling Point (SP) change information according to received state change information and SP information, and notify other relevant IPSTPs or IPSEPs through an extended route management message.

5. The network system of claim 1, wherein:
the IPSTP is further configured to start a corresponding route detection process to check for recovery of the route periodically after receiving an extended route management message about fault of an M3UA protocol entity.

6. The network system of claim 1, wherein:
the IPSEP is further configured to update maintained route state after receiving a route management message about route failure or route congestion, and start a route detection process to check for recovery of the route periodically.

7. The network system of claim 1, wherein the IPSEP is further configured to notify detected state change information to the relevant SPs.

8. The network system of claim 7, wherein:
if the detected state change information is information about unavailability of the upper-layer user part, the IPSEP is further configured to notify the information about unavailability of the upper-layer user part to the relevant SPs through an extended Destination User Part Unavailable (DUPU) message after detecting the unavailability;
if the detected state change information is congestion information, the IPSEP is further configured to notify the congestion information to the relevant SPs through an extended Signaling Congestion (SCON) message after detecting the congestion; and
if the detected state change information is fault, the IPSEP is further configured to notify the fault to the relevant SPs through a Destination Unavailable (DUNA) message after detecting the fault.

9. The network system of claim 1, wherein:
the IPSEP is further configured to notify information about unavailability or congestion to an origination SP of a signaling service message through a DUPU message or an SCON message if discovering that an upper-layer user part is unavailable or detecting congestion after receiving a signaling service message.

10. A method for transmitting signaling service messages in a network capable of M3UA-based networking, wherein the method enables setting of multi-hop route information corresponding to the route flag and comprises:
receiving an M3UA-based signaling service message; and
determining route information according to the route flag carried in a signaling service message, and sending the signaling service message through the determined route.

11. The method of claim 10, wherein the sending the signaling service message through the determined route comprises:
sending signaling service message to a next-hop M3UA protocol entity according to the route information and a route key processing flow specified in the M3UA protocol, wherein the next-hop M3UA protocol entity receives the signaling service message and determines the local termination, and reports the signaling service message to the local upper-layer user.

12. A signaling transfer point over internet protocol (IPSTP), comprising:
a signal transferring module, configured to receive a signaling service message, and transfer the signaling service message according to the route information maintained by the signaling transferring module;
a route management message processing module, configured to transfer the obtained state change information according to the destination address of the signaling service message; and
a route state updating module, configured to update the route information according to the obtained state change information.

13. The IPSTP of claim 12, further comprising:
a route storing module, configured to store routes.

14. The IPSTP of claim 12, further comprising:
a detecting module, configured to send the state information of the route or SP to the route state updating module and the route management message processing module after detecting state change of the route or the SP.
